(19) United States
(12) Patent Application Publication
(10) Pub. No.: US 2018/0323632 A1
(43) Pub. Date: Nov. 8, 2018

(54) DOOR LOCK MECHANISM

(71) Applicant: Western Digital Technologies, Inc., San Jose, CA (US)

(72) Inventor: Shaun Astarabadi, Laguna Niguel, CA (US)

(21) Appl. No.: 15/588,172

(22) Filed: May 5, 2017

(51) Int. Cl. H02J 7/02; H02J 7/00; H02J 50/10; E05B 47/00; H02K 7/06; H02K 37/24; G07C 9/00

(52) U.S. Cl. CPC H02J 7/025; H02J 7/0063; H02J 50/10; E05B 47/0012; G07C 2009/00769; H02K 37/24; G07C 9/00174; E05B 2047/0084; E05B 2047/0061; H02K 7/06

(57) ABSTRACT

A lock mechanism for a door including a deadbolt configured to be positioned in an extended first position and a retracted second position. The lock mechanism further includes an actuator for moving the deadbolt between the first and second positions, and a rechargeable battery for powering the actuator. A receiving coil of the lock mechanism generates an induced current for charging the rechargeable battery. The receiving coil is configured to generate the induced current from an electromagnetic field generated by a transmitting coil facing the receiving coil and located on an interior surface of a door frame for the door.

### BACKGROUND

Electronic door locks and other door or window mounted electronic devices, such as door bells, position sensors, and cameras, usually require power to operate. Such door or window mounted devices typically use replaceable batteries for power, since it is generally difficult to provide wiring to a moveable door or window.

In addition to the inconvenience of having to replace batteries, the use of batteries for door or window mounted devices can cause reliability problems for the device. For example, in the case of an electronic door lock, a user can be locked out if its battery can no longer supply sufficient power to unlock the door. In the case of a doorbell, an occupant may miss a visitor if the doorbell fails to alert the occupant due to a dead battery. To make matters worse, door and window mounted devices are beginning to provide more sophisticated functions such as video transmission, network connectivity (e.g., WiFi), and additional processing at the device, such as fingerprint scanning. Such additional functions can lead to an even shorter battery life due to the additional power needed to perform the additional functions.

### BRIEF DESCRIPTION OF THE DRAWINGS

The features and advantages of the embodiments of the present disclosure will become more apparent from the detailed description set forth below when taken in conjunction with the drawings. The drawings and the associated descriptions are provided to illustrate embodiments of the disclosure and not to limit the scope of what is claimed.

FIG. 1 is a perspective view of a door including a lock mechanism according to an embodiment.

FIG. 2 is an exploded perspective view of the lock mechanism of FIG. 1.

FIG. 3 is a second exploded perspective view of the lock mechanism of FIG. 1.

FIG. 4 is a rear view of an actuator of the lock mechanism with a rear portion of the actuator's housing removed according to an embodiment.

FIG. 5 is a perspective view of a door including a lock mechanism according to an embodiment.

FIG. 6 is a perspective view of a charging system used with a window mounted device according to an embodiment.

FIG. 7A is a perspective view of a door mounted keypad device connected to a charging system according to an embodiment

FIG. 7B is a perspective view of a door mounted device including a doorbell, biometric sensor, and camera that is connected to a charging system according to an embodiment.

### DETAILED DESCRIPTION

In the following detailed description, numerous specific details are set forth to provide a full understanding of the present disclosure. It will be apparent, however, to one of ordinary skill in the art that the various embodiments disclosed may be practiced without some of these specific details. In other instances, well-known structures and techniques have not been shown in detail to avoid unnecessarily obscuring the various embodiments.

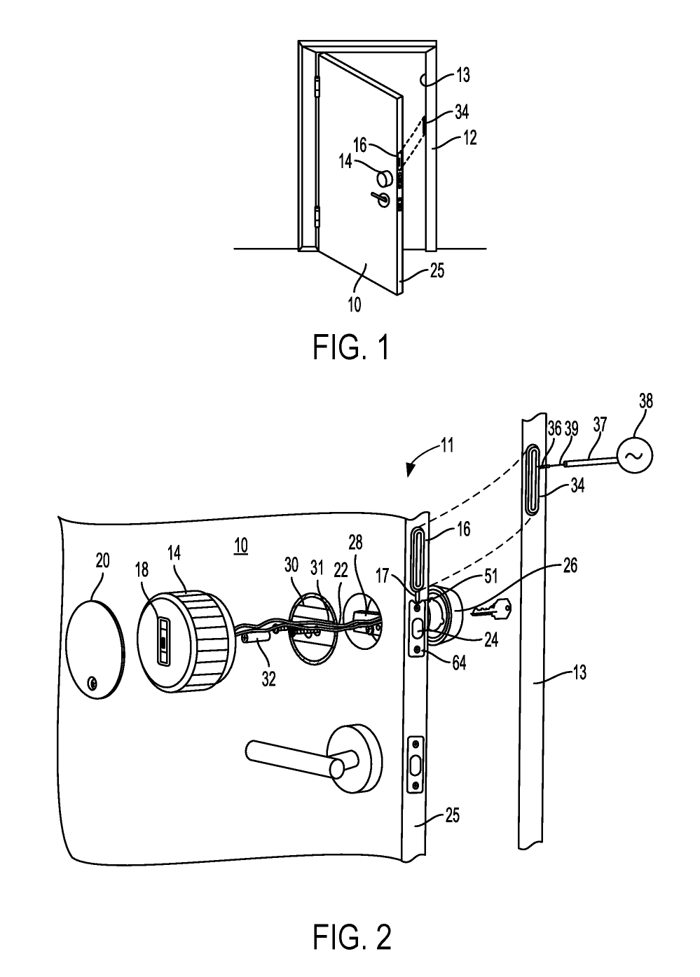

FIGS. 1 and 2 provide a perspective view and an exploded view, respectively, of door 10 including lock mechanism 11 according to an embodiment. Lock mechanism 11 of FIGS. 1 and 2 includes deadbolt 24 for locking door 10 within door frame 12. Deadbolt 24 can be moved between an extended or locked first position and a retracted or unlocked second position, which is shown in FIGS. 1 and 2. In more detail, deadbolt 24 may be moved by either a key manually inserted and turned in outside cylinder 26 on an exterior of door 10 or by actuator 14 on an interior of door 10.

Actuator 14 can include a motor (e.g., motor 76 in FIG. 4) for rotating tail adapter 32, which in turn, slides cam 28 horizontally to move deadbolt 24 between the first and second positions. In some implementations, actuator 14 can also include circuitry (e.g., circuitry 80 in FIG. 4) to wirelessly lock or unlock door 10 using, for example, an internet browser or application running on a computer or a smartphone.

As shown in FIGS. 1 and 2, actuator 14 can receive power from receiving coil 16, which generates an induced current for charging rechargeable battery 18, which is shown in FIG. 2 behind front cover 20 of actuator 14. A length of receiving coil 16 is greater than a width of receiving coil 16 so that the length of receiving coil 16 extends along a length of edge surface 25. In the example of FIG. 1, receiving coil 16 is located on edge surface 25 of door 10 from which deadbolt 24 is configured to extend from plate 64 affixed to edge surface 25.

As indicated by the dashed lines in FIGS. 1 and 2, when door 10 is closed within door frame 12, receiving coil 16 aligns with transmitting coil 34, which for its part, generates an electromagnetic field that receiving coil 16 uses to generate the induced current for charging rechargeable battery 18. Transmitting coil 34 is located on interior surface 13 of door frame 12 so that it faces receiving coil 16 when door 10 is closed.

Receiving coil 16 and transmitting coil 34 are induction coils made from a looped conductive wire (e.g., copper or silver wire) capable of inductive electric coupling to wirelessly transfer power from transmitting coil 34 to receiving coil 16 via an electromagnetic field generated by transmitting coil 34 (i.e., inductive charging). In more detail, transmitting coil 34 generates an alternating electromagnetic field that induces an electric current in receiving coil 16 when it is in proximity to transmitting coil 34 when door 10 is closed. This arrangement ordinarily allows for a constant charging of battery 18 when door 10 is closed. Since door 10 may be closed for long periods of time or more often closed than open, receiving coil 16 may charge battery 18 at a relatively low power over a long period of time.

Receiving coil 16 and transmitting coil 34 are configured to be located on an edge surface of a door (e.g., edge surface 25) and an interior surface of a door frame (e.g., interior surface 13), respectively. In some implementations, a length, width, and/or thickness of receiving coil 16 may be sized to fit a particular edge surface size or range of sizes for a door. Similarly, a length, width, and/or thickness of transmitting coil 34 may be sized to fit a particular interior surface size or range of sizes for a door frame. In addition, the wire material, thickness, and number of loops or windings of the wire in receiving coil 16 and transmitting coil 34 may depend on the sizes of receiving coil 16 and transmitting coil 34 and an expected distance or range of distances between transmitting coil 34 and receiving coil 16 when the door is closed within the door frame to induce a certain level of current in receiving coil 16. In addition, receiving coil 16 and transmitting coil 34 may include a protective covering or film (e.g., plastic) to protect against damage when located on a door or door frame.

Lead 36 connects transmitting coil 34 to Alternating Current (AC) power supply 38 with wires 39. Lead 36 may also serve to protect wires 39 within lead 36 from damage due to contact or environmental conditions such as weather. As shown in FIG. 2, wires 39 may optionally be enclosed within cable 37 within a wall adjacent door frame 12. Power supply 38 may include, for example, a low voltage circuit for powering a doorbell (e.g., 6 to 24 Volt, 60 Hertz), or a mains (e.g., 120 Volt, 60 Hertz) power circuit. In some installations, a doorbell may be near to door 10 and allow for convenient access to power.

In the example of FIG. 2, receiving coil 16 and transmitting coil 34 are thin coils or loops of wire that can be affixed to edge surface 25 of door 10 and interior surface 13 of door frame 12, respectively, without interfering with the opening and closing of door 10. In some implementations, receiving coil 16 and transmitting coil 34 can be taped or glued to edge surface 25 and interior surface 13, respectively.

The example of FIG. 2 includes lead 17 connected to receiving coil 16. Lead 17 can protect wires 22 within lead 17 from damage due to contact and environmental conditions such as weather. Lead 17 may also allow for an easier installation of lock mechanism 11. In this regard, lead 17 in FIG. 2 is channeled or fed through notch 51 in plate 64 and into the cutout in door 10 for cam 28 and deadbolt 24. Lead 17 is then passed through opening 31 in mounting plate 30 before wires 22 are connected to the rear of actuator 14.

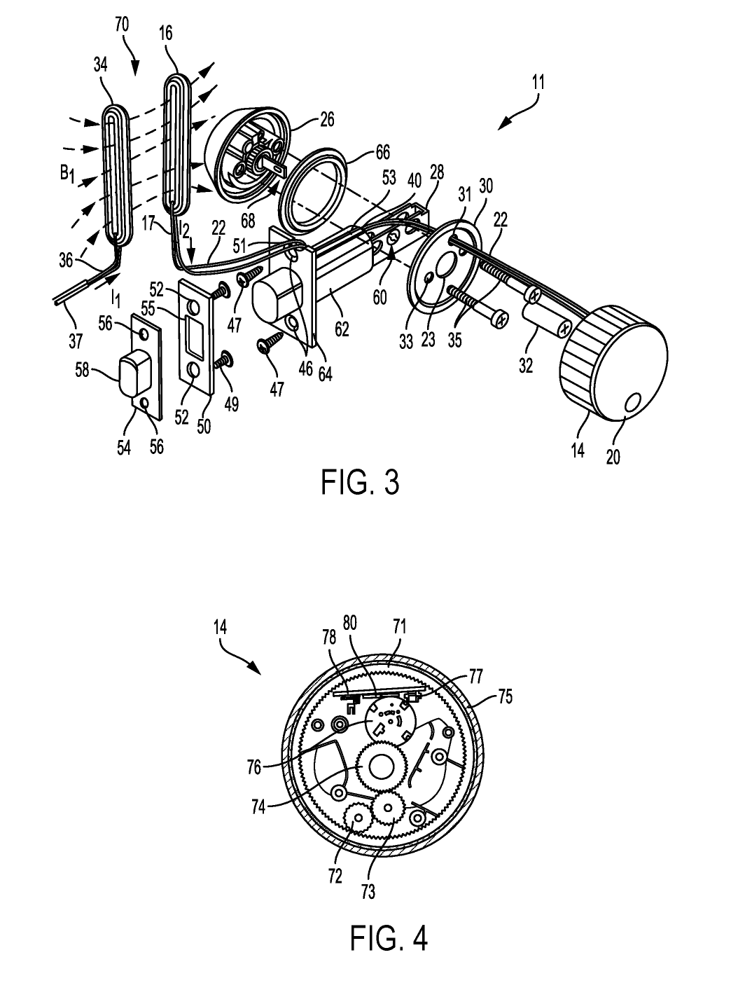

Those of ordinary skill in the art will appreciate that lock mechanism 11 and door 10 may include different components or a different arrangement or configuration of components than those shown in FIGS. 1 and 2. For example, FIGS. 3, 4, and 5 discussed below include additional detail not shown in FIGS. 1 and 2.

FIG. 3 is a second exploded perspective view showing additional detail for lock mechanism 11 and charging system 70. As shown in FIG. 3, lock mechanism 11 includes outside cylinder 26 that is mounted on exterior mount 66, which is secured to an exterior of door 10. In operation, tail 68 of outside cylinder 26 slides cam 28 via rotation in a first direction (e.g., counter-clockwise) at connector 60. The sliding of cam 28 pushes deadbolt 24 through housing 62 so that deadbolt 24 extends from plate 64 and housing 62 into an extended or locked first position as shown in FIG. 3. When connector 60 is rotated in a second direction opposite the first direction (e.g., clockwise), cam 28 pulls deadbolt 24 in so that deadbolt 24 retracts into plate 64 and housing 62 into a retracted or unlocked second position as shown in FIGS. 1 and 2.

Plate 64 is secured to edge surface 25 of door 10 with screws 47 through holes 46. Similarly, strike plate 50 is secured to interior surface 13 of door frame 12 with screws 49 through holes 52. As shown in FIG. 3, strike plate 50 and box plate 54 are positioned to allow insertion of deadbolt 24 through space 55 of strike plate 50 and into recess 58 of box plate 54 when deadbolt 24 is in the extended first position, thereby locking door 10 within door frame 12. Box plate 54 is secured to interior surface 13 of door frame 12 with screws 49 through holes 56.

On an interior side of door 10, actuator 14 is secured to door 10 with a press fitting onto mounting plate 30, which is affixed to door 10 with screws 35 through holes 33. Tail adapter 32 is positioned through adapter hole 23 of mounting plate 30 to connect with tail 68 extending through connector 60 of cam 28.

As discussed above, actuator 14 is powered by rechargeable battery 18 located under cover 20, which is charged by charging system 70. As shown in the example of FIG. 3, charging system 70 includes transmitting coil 34, which is powered by power supply 38 via lead 36 and cable 37 to generate an alternating electromagnetic field, B₁, shown in FIG. 3 with dashed lines through transmitting coil 34 and receiving coil 16. The electromagnetic field generated by transmitting coil 34 induces an electric current in receiving coil 16 that charges rechargeable battery 18 via wires 22 in lead 17. As shown in FIG. 3, lead 17 or wires 22 may be guided though notch 51 and guide 53 on housing 62. Lead 17 or wires 22 may then be guided through wire hole 31 of mounting plate 30 to keep lead 17 or wires 22 from interfering with mechanical operation of lock mechanism 11.

As will be appreciated by those of ordinary skill in the art, different components and variations in component arrangement are possible for lock mechanism 11 than those shown in FIG. 3.

FIG. 4 is a rear view of actuator 14 with a rear portion of housing 75 removed to reveal components inside actuator 14 according to an embodiment. As shown in FIG. 4, actuator 14 includes motor 76 for rotating tail adapter 32 via one or more gear stages (not shown). Motor 76 may include, for example, a Direct Current (DC) step motor for turning tail adapter 32. The operation of motor 76 is controlled by circuitry 80 on Printed Circuit Board (PCB) 78.

In the example of FIG. 4, PCB 78 includes power input 77 for receiving wires 22 or lead 17. In this regard, circuitry 80 includes components for charging rechargeable battery 18. Such components may include, for example, a rectifier for converting AC power to DC power and/or a voltage regulator to provide a steady charge to rechargeable battery 18.

Circuitry 80 can also include one or more processors for executing instructions and can include, for example, a microcontroller, a Digital Signal Processor (DSP), an Application-Specific Integrated Circuit (ASIC), a Field Programmable Gate Array (FPGA), a System on a Chip (SoC), hard-wired logic, analog circuitry and/or a combination thereof.

In some implementations, circuitry 80 can communicate with one or more remote electronic devices, such as a smartphone, Network Attached Storage (NAS), alarm panel, server, or a computer using a wireless technology standard such as WiFi or Bluetooth. Such communication can facilitate features such as, for example, remote or automatic locking and unlocking of lock mechanism 11, the logging of when and/or what device locks or unlocks lock mechanism 11, or a position of door 10.

In some implementations, circuitry 80 is configured to determine whether receiving coil 16 is generating an induced current for indicating whether door 10 is in an open position or a closed position. When door 10 is closed within door frame 12, receiving coil 16 is aligned with transmitting coil 34, thereby generating the induced current. Circuitry 80 may sense this induced current and send an indication to a remote electronic device that door 10 is in a closed position. On the other hand, when circuitry 80 stops sensing the induced current, circuitry 80 may send an indication to the remote electronic device that door 10 is in an open position.

In addition, circuitry 80 may indicate whether lock mechanism 11 is in a locked or unlocked position based on a position of motor 76, corresponding to a position of tail adapter 32 and deadbolt 24. The locked or unlocked indication may be displayed locally on actuator 14 with one or more lights (e.g., Light Emitting Diodes (LEDs)) in actuator 14. In some implementations, the locked or unlocked indication may be sent to a remote electronic device using circuitry 80 via a wireless network.

In the example of FIG. 4, actuator 14 also includes gears 71, 72, 73, and 74 for manually actuating deadbolt 24 by turning an exterior of housing 75. In operation, a user turns housing 75 in either a clockwise or counter-clockwise direction to turn ring gear 71 connected to an interior of housing 75. The turning of ring gear 71 turns planetary gears 72 and 73, which turn sun gear 74 to rotate tail adapter 32, thereby moving cam 28 and deadbolt 24.

Other implementations of actuator 14 may vary from the arrangement shown in FIG. 4. For example, some implementations may locate circuitry 80 or motor 76 in different positions or use a different gear configuration.

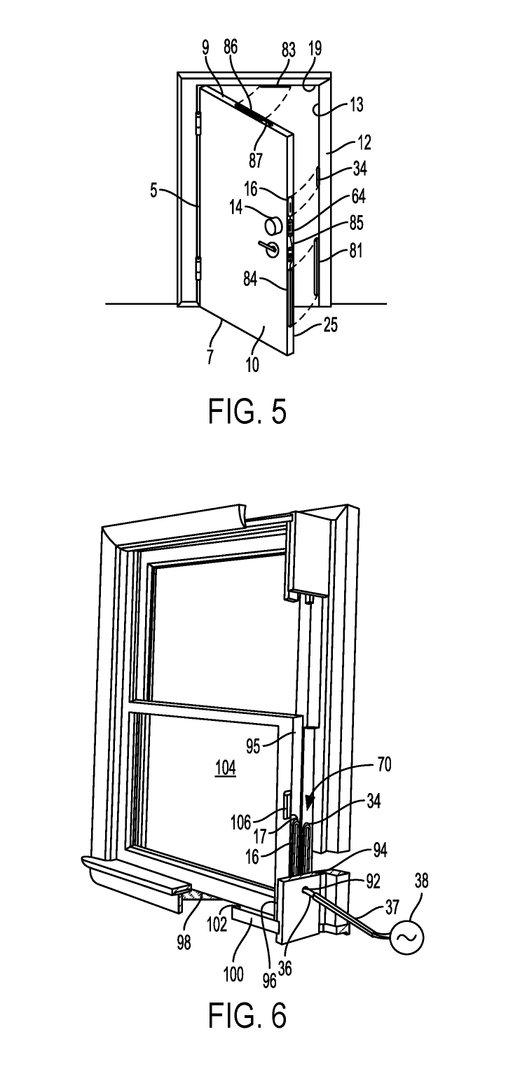

FIG. 5 is a perspective view of door 10 including lock mechanism 11 according to an embodiment where additional receiving coils 84 and 86 have been added to edge surfaces 25 and 9, respectively, of door 10. As shown in FIG. 5, receiving coils 84 and 86 are longer than receiving coil 16, which can ordinarily allow for a greater current to be induced in receiving coils 84 and 86 than in receiving coil 16.

In the example of FIG. 5, receiving coil 84 is located on edge surface 25 such that when door 10 is closed within door frame 12, a current is induced in receiving coil 84 from an alternating electromagnetic field generated by transmitting coil 81, which is located on interior surface 13 of door frame 12. Lead 85 connects receiving coil 84 to actuator 14 by being guided into door 10, such as through a notch in plate 64. Lead 85 may also serve to protect wires within lead 85 from damage due to contact or environmental conditions.

Transmitting coil 81 is aligned with or facing receiving coil 84 when door 10 is closed, as shown by the dashed lines connecting receiving coil 84 and transmitting coil 81 in FIG. 5. As with transmitting coil 34 discussed above, transmitting coil 81 may also be powered by power supply 38, which can include, for example, a low voltage circuit for powering a doorbell or a higher voltage mains power circuit.

Receiving coils 84 and 86, and transmitting coils 81 and 83 are induction coils made from a looped conductive wire (e.g., copper or silver wire) capable of inductive electric coupling to wirelessly transfer power from transmitting coils 81 and 83 to receiving coils 84 and 86, respectively, via alternating electromagnetic fields generated by transmitting coils 81 and 83 (i.e., inductive charging). Receiving coils 84 and 86, and transmitting coils 81 and 83 are thin coils or loops of wire that can be affixed to edge surfaces 25 and 9 of door 10, and interior surfaces 13 and 19 of door frame 12, respectively, without interfering with the opening and closing of door 10. In some implementations, receiving coils 84 and 86, and transmitting coils 81 and 83 can be taped or glued to edge surfaces 25 and 9 and interior surfaces 13 and 19, respectively.

The example of FIG. 5 includes lead 87 connected to receiving coil 86 and can serve to protect wires within lead 87 from damage due to contact and environmental conditions. Lead 87 may also allow for an easier installation of lock mechanism 11. In this regard, lead 87 can be channeled or fed into a hole on top edge surface 9 of door 10. Lead 87 can then be pulled through a cutout in door 10 for cam 28 and deadbolt 24, before being passed through opening 31 in mounting plate 30 for connection to an input on the rear of actuator 14.

In some implementations, actuator 14 can include additional inputs for electrical connection to receiving coils 84 and 86. In addition, circuitry 80 of actuator 14 may include, for example, components for converting from AC power to DC power, regulating the converted power, and summing the voltage received from receiving coils 16, 84, and 86.

Those of ordinary skill in the art will appreciate that other implementations of door 10 and lock mechanism 11 can include receiving coils in different locations such as on edge surfaces 5 or 7 of door 10. In such implementations, a corresponding transmitting coil is located on an interior surface of door frame 12 so that the transmitting coil faces the receiving coil when door 10 is closed.

FIG. 6 is a perspective view of a charging system 70 for window mounted device 106 according to an embodiment. In the example of FIG. 6, window mounted device 106 can be, for example, a position sensor, human presence sensor (e.g., infrared thermal sensor or movement sensor), or a glass break sensor. In the example of a position sensor, window mounted device 106 can include a magnetic sensor that detects a magnetic field from a corresponding permanent magnet (not shown) mounted on window frame 94. The opening of window 104 is then detected when device 106 no longer detects the magnetic field of the permanent magnet as window 104 is raised farther away from the permanent magnet.

As with actuator 14 discussed above with reference to FIGS. 1 to 5, circuitry within device 106 can include one or more processors for executing instructions and can include, for example, a microcontroller, a DSP, an FPGA, hard-wired logic, an SoC, analog circuitry and/or a combination thereof. The circuitry of device 106 can also include one or more inputs for receiving leads or wires supplying power for charging the battery of device 106.

In some implementations, the circuitry of device 106 can also communicate with one or more remote electronic devices, such as a smartphone, NAS, server, alarm panel, or a computer using a wireless technology standard such as WiFi, RF, or Bluetooth. Such communication can facilitate features such as remote detection of the opening or breaking of window 104.

As shown in FIG. 6, charging system 11 includes receiving coil 16 and transmitting coil 34. In some cases, the same components of charging system 11 can be configured for use on either a window or a door, such as door 10 in FIGS. 1 to 5. In the example of FIG. 6, device 106 can receive power from receiving coil 16, which generates an induced current for charging a rechargeable battery of device 106. Receiving coil 16 in FIG. 6 is located on edge surface 95 of window 104, with the length of receiving coil 16 being greater than the width of receiving coil 16 so that the length of receiving coil 16 extends along a length of edge surface 95.

When window 104 is lowered to window sill 100 of window frame 94, receiving coil 16 aligns with transmitting coil 34, which for its part, generates an alternating electromagnetic field that receiving coil 16 uses to generate the induced current for charging the rechargeable battery of device 106. Transmitting coil 34 is located on interior surface 96 of window frame 94 so that it aligns with and faces receiving coil 16 when window 104 is closed.

As noted above with reference to FIGS. 1 and 2, receiving coil 16 and transmitting coil 34 are induction coils made from a looped conductive wire (e.g., copper or silver wire) capable of inductive electric coupling to wirelessly transfer power from transmitting coil 34 to receiving coil 16 via an electromagnetic field generated by transmitting coil 34. This arrangement ordinarily allows for a constant charging of the battery in device 106 when window 104 is closed. Since window 104 may be closed for long periods of time or more often closed than open, receiving coil 16 may charge the battery at a relatively low power over a long period of time.

In the example of FIG. 6, receiving coil 16 and transmitting coil 34 are configured to be located on an edge surface of a window (e.g., edge surface 95) and an interior surface of a window frame (e.g., interior surface 96), respectively. In some implementations, a length, width, and/or thickness of receiving coil 16 may be sized to fit a particular edge surface size or range of sizes for a window. Similarly, a length, width, and/or thickness of transmitting coil 34 may be sized to fit a particular interior surface size or range of sizes for a window frame. In addition, the wire material, thickness, and number of loops or windings of the wire in receiving coil 16 and transmitting coil 34 may depend on the sizes of receiving coil 16 and transmitting coil 34 and an expected distance or range of distances between transmitting coil 34 and receiving coil 16 when the window is closed within the window frame to induce a certain level of current in receiving coil 16. In addition, receiving coil 16 and transmitting coil 34 may include a protective covering or film (e.g., plastic) to protect against damage when located on a window or window frame.

Lead 36 connects transmitting coil 34 to AC power supply 38 with wires (e.g., wires 39 in FIG. 2) inside lead 36. Lead 36 may also serve to protect the wire within lead 36 from damage due to contact or environmental conditions such as weather. As shown in FIG. 6, lead 36 may be optionally enclosed within cable 37 within a wall adjacent window frame 94. Power supply 38 may include, for example, a low voltage circuit, such as for powering a doorbell, or a mains power circuit.

In the example of FIG. 6, receiving coil 16 and transmitting coil 34 are thin coils or loops of wire that can be affixed to edge surface 95 of window 104 and interior surface 96 of window frame 94, respectively, without interfering with the opening and closing of window 104. In some implementations, receiving coil 16 and transmitting coil 34 can be taped or glued to edge surface 95 and interior surface 96, respectively.

The example of FIG. 6 includes lead 17 connected to receiving coil 16 and can serve to protect wires within lead 17 from damage due to contact and environmental conditions such as weather. Lead 17 may also allow for an easier installation of charging system 11. Similarly, lead 36 for transmitting coil 34 may be fed through hole 92 in window frame 94 and into a wall adjacent window frame 94.

In other implementations, charging system 11 may include additional pairs of receiving coils and transmitting coils on an edge surface and an interior surface of window frame 94. For example, some implementations of charging system 70 may include positioning receiving coil 16 or an additional receiving coil on bottom edge surface 98 of window 104 and positioning a corresponding transmitting coil on interior surface 102 of window frame 94, which includes window sill 100.

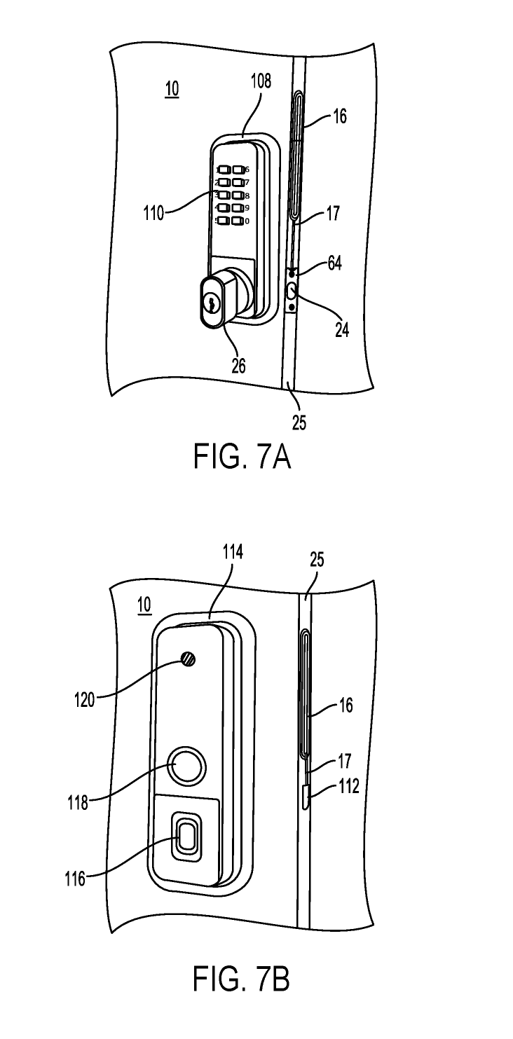

FIGS. 7A and 7B provide examples of door mounted devices that can be used with charging system 70 to charge a battery of the device. As in the examples of FIGS. 1 to 6, a battery of the device is charged using a current induced in receiving coil 16 from an alternating electromagnetic field generated by transmitting coil 34 (not shown) located on an interior surface of a frame.

FIG. 7A is a perspective view of lock mechanism 108 mounted on door 10 that includes keypad 110. As shown in FIG. 7A, lock mechanism 108 is a motorized lock that actuates or moves deadbolt 24 by either turning a key inserted into outside cylinder 26 or by entering a code using keypad 110 to activate a motor in lock mechanism 108 to retract or extend deadbolt 24. In the example of FIG. 7A, receiving coil 16 is positioned on edge surface 25 of door 10 with lead 17 being fed into plate 64 for connection to lock mechanism 108 within door 10.

FIG. 7B is a perspective view of door mounted device 114 including doorbell 118, biometric sensor 116, and camera 120. In the example of FIG. 7B, receiving coil 16 is positioned on edge surface 25 of door 10 with lead 17 being fed into plate 112 for connection to device 114 within door 10.

Biometric sensor 116 can include, for example, a fingerprint scanner or other biometric scanner. In this regard, circuitry of device 114 may alternatively or additionally use facial recognition with camera 120 to attempt to match stored facial geometry with an image of a face captured by camera 120. Circuitry of device 114 may determine whether a stored fingerprint pattern or the stored facial geometry matches sensor data received from biometric sensor 116 or camera 120 for determining whether to actuate deadbolt 24 to a retracted or unlocked position. In some implementations, camera 120 may also provide a video stream that is transmitted by circuitry of device 114 to a remote electronic device.

In other embodiments, device 114 may include a Radio Frequency Identifier (RFID) reader that allows device 114 to generate an electromagnetic field for identifying a Radio Frequency (RF) tag, such as an RF tag in a key card or wrist band.

The foregoing description of the disclosed example embodiments is provided to enable any person of ordinary skill in the art to make or use the embodiments in the present disclosure. Various modifications to these examples will be readily apparent to those of ordinary skill in the art, and the principles disclosed herein may be applied to other examples without departing from the spirit or scope of the present disclosure. The described embodiments are to be considered in all respects only as illustrative and not restrictive, and the scope of the disclosure is, therefore, indicated by the following claims rather than by the foregoing description. All changes which come within the meaning and range of equivalency of the claims are to be embraced within their scope.

What is claimed is:

1. A lock mechanism for a door, comprising:
a deadbolt configured to be positioned in an extended first position and a retracted second position;
an actuator for moving the deadbolt between the first and second positions;
a rechargeable battery for powering the actuator; and
a receiving coil for generating an induced current for charging the rechargeable battery from an electromagnetic field generated by a transmitting coil facing the receiving coil and located on an interior surface of a door frame for the door.

2. The lock mechanism of claim 1, wherein the receiving coil is configured to be located on a side, top, or bottom edge surface of the door.

3. The lock mechanism of claim 1, wherein a length of the receiving coil is greater than a width of the receiving coil so that the length of the receiving coil is configured to extend along a length of an edge surface of the door.

4. The lock mechanism of claim 1, further comprising circuitry configured to:
determine whether the receiving coil is generating the induced current; and
indicate a position of the door based on whether the receiving coil is generating the induced current.

5. The lock mechanism of claim 1, further comprising circuitry configured to wirelessly communicate with a remote electronic device.

6. The lock mechanism of claim 1, further comprising a second receiving coil for charging the rechargeable battery, such that the second receiving coil is configured to be located on an edge surface of the door such that when the door is closed, the second receiving coil generates a second induced current from a second electromagnetic field generated by a second transmitting coil facing the second receiving coil on the interior surface or another interior surface of the door frame.

7. The lock mechanism of claim 1, wherein the transmitting coil is configured to receive power from a circuit for powering a doorbell or from a mains power circuit.

8. A charging system for a device configured to be located on a window or a door, the charging system comprising:
a transmitting coil configured to be located on an interior surface of a frame for the window or the door and to generate an electromagnetic field; and
a receiving coil configured to be located on an edge surface of the window or the door and to generate an induced current from the electromagnetic field generated by the transmitting coil, wherein the generated induced current charges a rechargeable battery of the device.

9. The charging system of claim 8, wherein the receiving coil is further configured to be located on a side, top, or bottom edge surface of the window or the door.

10. The charging system of claim 8, wherein a length of the receiving coil is greater than a width of the receiving coil so that the length of the receiving coil is configured to extend along a length of the edge surface.

11. The charging system of claim 8, wherein the device comprises circuitry configured to:
determine whether the receiving coil is generating the induced current; and
indicate a position of the window or the door based on whether the receiving coil is generating the induced current.

12. The charging system of claim 8, wherein the device comprises circuitry configured to wirelessly communicate with a remote electronic device.

13. The charging system of claim 8, further comprising:
a second transmitting coil configured to be located on the interior surface or another interior surface of the frame and to generate a second electromagnetic field; and
a second receiving coil configured to be located on the edge surface or another edge surface of the window or the door such that when the window or the door is closed, the second receiving coil generates a second induced current from the second electromagnetic field for charging the rechargeable battery.

14. The charging system of claim 8, wherein the transmitting coil is configured to receive power from a circuit for powering a doorbell or from a mains power circuit.

15. The charging system of claim 8, wherein the device is at least one of a motorized lock, a door or window position sensor, a video camera, a doorbell, a biometric sensor, a Radio Frequency Identification (RFID) reader, and a keypad.

16. A door, comprising:
a deadbolt configured to be positioned in a first extended position and in a second retracted position;
an actuator for moving the deadbolt between the first and second positions;
a rechargeable battery for powering the actuator; and
a receiving coil located on an edge surface of the door, wherein the receiving coil is configured to generate an induced current for charging the rechargeable battery from an electromagnetic field generated by a transmitting coil facing the receiving coil when the door is closed and located on an interior surface of a door frame for the door.

17. The door of claim 16, wherein the receiving coil is located on a side, top, or bottom edge surface of the door.

18. The door of claim 16, wherein a length of the receiving coil is greater than a width of the receiving coil such that the length of the receiving coil extends along a length of the edge surface of the door.

19. The door of claim 16, further comprising circuitry configured to:
determine whether the receiving coil is generating the induced current; and
indicate a position of the door based on whether the receiving coil is generating the induced current.

20. The door of claim 16, further comprising a second receiving coil for charging the rechargeable battery and located on the edge surface or another edge surface of the door such that when the door is closed, the second receiving coil is configured to generate a second induced current from a second electromagnetic field generated by a second transmitting coil facing the second receiving coil on the interior surface or another interior surface of the door frame.
